(19) United States
(12) Patent Application Publication
(10) Pub. No.: US 2008/0149061 A1
(43) Pub. Date: Jun. 26, 2008

(54) Method and Control Unit for Checking an Adjustment of a Length of an Intake Manifold in an Internal Combustion Engine

(75) Inventors: Thomas Rauner, Blaubeuren (DE); Bjorn Muller, Altenstadt (DE)

Correspondence Address: LERNER GREENBERG STEMER LLP, P O BOX 2480, HOLLYWOOD, FL, 33022-2480, US

(73) Assignee: DR. ING. H.C. F. PORSCHE AKTIENGESELLSCHAFT, Weissach (DE)

(21) Appl. No.: 11/963,962

(22) Filed: Dec. 24, 2007

(30) Foreign Application Priority Data
Dec. 23, 2006 (DE) 102006061438.0

(51) Int. Cl. F02M 35/104

(52) U.S. Cl. 123/184.55

(57) ABSTRACT

A method checks the adjustment of the length or volume of an intake manifold in an internal combustion engine which, when there is a functionally capable adjustment of the length of the intake manifold, is operated with a first, comparatively large intake manifold length when there is a first, comparatively low rotational speed, and is operated with a second, comparatively small intake manifold length when there is a second, comparatively high rotational speed. In the method, a measure is formed for an actual value of the power or of the torque of the internal combustion engine from operating parameters which are sensed for controlling the internal combustion engine during its operation. The measure is compared with a predetermined setpoint value, and the check is carried out in dependence on the result of the comparison. In addition, a control unit is configured to carry out the method.

### CROSS-REFERENCE TO RELATED APPLICATION

This application claims the priority, under 35 U.S.C. § 119, of German application DE 10 2006 061 438.0, filed Dec. 23, 2006; the prior application is herewith incorporated by reference in its entirety.

### BACKGROUND OF THE INVENTION

### Field of the Invention

The invention relates to a method for checking an adjustment of a length of an intake manifold in an internal combustion engine. When there is a functionally capable adjustment of the length of the intake manifold, the engine is operated with a first, comparatively large intake manifold length when there is a first, comparatively low rotational speed, and is operated with a second, comparatively small intake manifold length when there is a second, comparatively high rotational speed. The invention also relates to a control unit.

The adjustment of the length of an intake manifold or the volume is a known measure for improving the torque profile over the rotational speed of an internal combustion engine and is based on the following effect: by opening and closing the inlet valves of the internal combustion engine, the column of air or fuel/air mixture which is located in front of each inlet valve in the intake manifold is caused to oscillate. When the frequency and amplitude are suitable, the charge of the combustion chamber is improved, and the torque and the power of the internal combustion engine are thus increased.

This improvement occurs within a certain bandwidth of rotational speeds in the vicinity of a resonance rotational speed which correlates with the mass of the oscillating air column and thus with the length of the intake manifold. When there is a comparatively low rotational speed, the improved charge occurs when there is a comparatively large intake manifold length. Conversely, short intake manifold lengths lead to an improved charge when there are comparatively high rotational speeds.

Adjusting the length of the intake manifold adapts the intake manifold length to the rotational speed in order to bring about the improved charge both at low and high rotational speeds.

If an incorrect adjustment of the length of the intake manifold results in a short intake manifold length when the rotational speeds are low, the torque and the power of the internal combustion engine will be lower in such a case than would be expected in the case of an optimum intake manifold length. Analogously, a loss of torque and a loss of power occur when there are high rotational speeds if there is a large intake manifold length there owing to a fault. The aforesaid losses can reach an order of magnitude of eight to 10%.

German patent DE 197 27 669, corresponding to U.S. Pat. No. 6,546,789, discloses a method and a control unit for checking an adjustment of the length of an intake manifold. In the known subject matter, it is assumed that a defective adjustment of the length of the intake manifold is influencing the exhaust gas emissions and therefore needs to be detected through legally prescribed on-board diagnostic methods. In this context, the known subject matter provides for the pressure of the intake manifold to be calculated from values of the rotational speed and of the air mass flow rate of the internal combustion engine for two different positions of the intake manifold valve, and to sense it with a pressure sensor simultaneously with this. In order to check an adjustment of the length of the intake manifold, differences between the intake manifold pressures which are calculated and those which are measured are formed and evaluated at the different intake manifold valve positions.

Although it has become apparent that the requirements of legislators can also be met without on-board diagnostics of the adjustment of the length of the intake manifold, it is desirable to be able to check the adjustment of the length of the intake manifold. It is thus possible, for example, that the large intake manifold length cannot be set. In this case, the internal combustion engine would supply at low to medium rotational speeds under full load only approximately 90% of the torque which it would make available in the fault-free state.

In contrast to a lack of power at high rotational speeds, the decreases in torque at low to medium rotational speeds cannot readily be determined quantitively. A lack of power at high rotational speeds is manifested, for example, in a reduction in the achievable maximum velocity and can therefore in principle be detected objectively by the driver using the existing instrumentation. In contrast, a lack of power at low to medium rotational speeds cannot readily be detected solely from velocity displays and/or rotational speed displays, but under certain circumstances it nevertheless gives the vague impression that the vehicle is not accelerating to an optimum extent.

If a driver who has this impression takes his vehicle to a repair shop, the adjustment of the length of the intake manifold can also be checked there only to a limited degree since the adjustment mechanism in modern intake manifold modules is frequently no longer accessible without destroying the intake manifold module.

In principle, the subject matter known from German patent DE 197 27 669 could be used to check the adjustment of the length of the intake manifold. However, the known subject matter requires both an air mass flow rate meter and an intake manifold pressure sensor. Both sensors are in principle suitable for sensing the load of the internal combustion engine. The load of the internal combustion engine is generally understood to mean the value of a combustion chamber charge after standardization to a maximum combustion chamber charge which can be achieved under standard conditions.

Using a plurality of load sensors in parallel is in principle considered disadvantageous in terms of achieving the lowest possible degree of complexity, lowest possible costs and maximum level of reliability of the control system for the internal combustion engine.

### SUMMARY OF THE INVENTION

It is accordingly an object of the invention to provide a method and a control unit for checking an adjustment of a length of an intake manifold in an internal combustion engine that overcomes the above-mentioned disadvantages of the prior art methods and devices of this general type, which respectively permits the adjustment of the length of an intake manifold to be checked with a less costly sensor system.

With the foregoing and other objects in view there is provided, in accordance with the invention, a method for checking an adjustment of a length or volume of an intake manifold in an internal combustion engine. When there is a functionally capable adjustment of the length of the intake manifold the internal combustion engine is operated with a first, comparatively large intake manifold length during a first, comparatively low rotational speed, and the internal combustion engine is operated with a second, comparatively small intake manifold length during a second, comparatively high rotational speed being high relative to the first, comparatively low rotational speed. The first, comparatively large intake manifold length is larger than the second, comparatively small intake manifold length. The method includes the steps of: forming a measure for an actual value of power or torque of the internal combustion engine from operating parameters sensed for controlling the internal combustion engine during operation; comparing the measure with a predetermined setpoint value; and determining a completion of a successful adjustment of the length or the volume of the intake manifold in dependence on a result of a comparison.

By comparing an actual value of the power or of the throughput quantity of air as a function of the external temperature and geodetic altitude or the torque of the internal combustion engine with a predetermined setpoint value, a power loss or torque loss can be detected directly from the result of the comparison. If the setpoint value is not reached, a fault is present. Since the checking of an adjustment of the length of the intake manifold is carried out in dependence on the result of the comparison, a detected fault is assigned to a defective adjustment of the length of the intake manifold or volume as its probable cause.

Since a measure for an actual value of the power or of the torque is formed from operational characteristic variables which are sensed for a control operation of the internal combustion engine, multiple use of these operational characteristic variables takes place. This permits the adjustment of the length of the intake manifold to be checked without an additional sensor, and thus overall with a less costly sensor system.

In accordance with an added mode of the invention, there is the step of determining the measure in dependence on an integral of a quantity of air flowing into the internal combustion engine. Alternatively, the measure can be formed in dependence on an integral of a torque signal formed in a control unit of the internal combustion engine.

In accordance with another mode of the invention, there is the step of performing the method during a full-load operating state of the internal combustion engine.

In accordance with a further mode of the invention, there is the step of using only measures formed during rotational speeds of the internal combustion engine that passed through a predetermined bandwidth of rotational speed values.

In accordance with yet another mode of the invention, there are the steps of forming a first measure for the actual value of the power or the torque of the internal combustion engine when there is the first, comparatively low rotational speed; and suspecting a fault in the adjustment of the length of the intake manifold if the first measure is lower than a first setpoint value predetermined for the comparatively low rotational speed.

In accordance with another added mode of the invention, the following steps are performed when there is the second, comparatively high rotational speed: signaling the intake manifold to form the first, comparatively large intake manifold length; forming a second setpoint value of the power or the torque of the internal combustion engine for the first, comparatively large intake manifold length; forming a second measure for the actual value of the power or the torque when there is the second, comparatively high rotational speed; and confirming a suspicion of the fault if the second measure is higher than the second setpoint value.

In accordance with a concomitant mode of the invention, the following steps are performed when there is the second, comparatively high rotational speed: forming a further setpoint value of the power or the torque of the internal combustion engine for the second, comparatively small intake manifold length; forming a further measure for the actual value of the power or the torque of the internal combustion engine when there is the second, comparatively high rotational speed; comparing the further measure with the further setpoint value; and generating a fault message if the further measure is lower than the further setpoint value.

Of course, the features which are mentioned above and those which are to be explained below can be used not only in the respectively specified combination but also in other combinations or alone without departing from the scope of the present invention.

Other features which are considered as characteristic for the invention are set forth in the appended claims.

Although the invention is illustrated and described herein as embodied in a method and a control unit for checking an adjustment of a length of an intake manifold in an internal combustion engine, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIGS. 1A and 1B are diagrammatic, illustrations of an internal combustion engine with an intake manifold with an adjustable length or volume; and

FIG. 2 is a flowchart showing an exemplary embodiment of a method according to the invention.

### DETAILED DESCRIPTION OF THE INVENTION

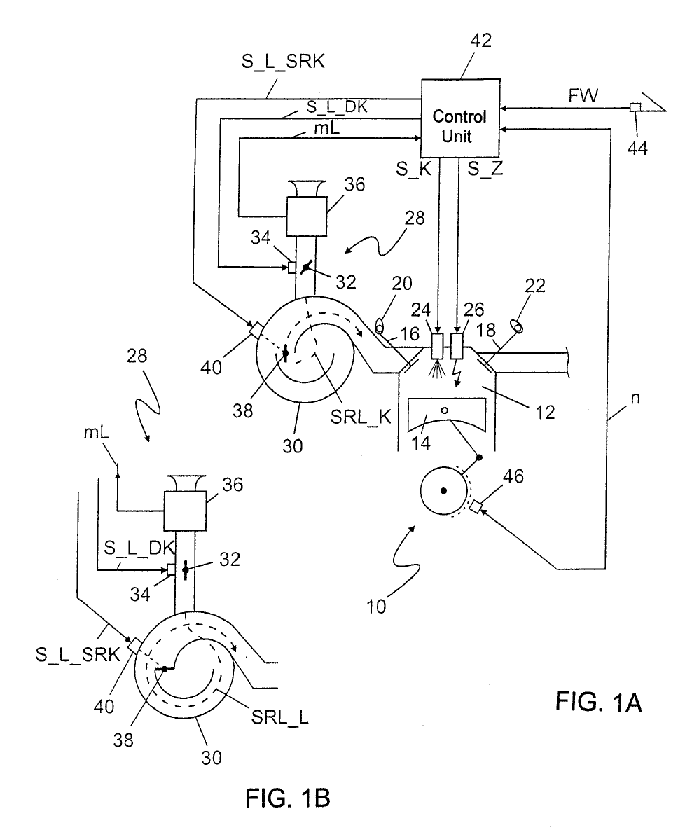

Referring now to the figures of the drawing in detail and first, particularly, to FIGS. 1A and 1B thereof, there is shown an internal combustion engine 10 with a combustion chamber 12 which is movably sealed off by a piston 14. An exchange of the charges of the combustion chamber 12 is controlled by at least one inlet valve 16 and one outlet valve 18, which are activated for this purpose by corresponding actuators 20, 22. In the embodiment in FIG. 1A, an injector 24 is used to meter fuel into an air charge of the combustion chamber 12. The resulting mixture of fuel and air is ignited by a sparkplug 26.

The charging of the combustion chamber 12 with air is done from an intake system 28 which has a switchable intake manifold 30 as an embodiment of a device for adjusting the length of an intake manifold, a throttle valve 32, which is activated by a throttle valve actuator 34, and an air mass flow rate meter 36. The switchable intake manifold 30 has an intake manifold valve 38 which is activated by an intake manifold valve actuator 40. In FIG. 1A, the intake manifold valve 38 is opened. As a result, the short intake manifold length SRL_K which is illustrated by dashed lines occurs. In contrast, FIG. 1B shows the intake manifold valve 38 in a closed position in which the long intake manifold length SRL_L represented by dashed lines occurs.

The internal combustion engine 10 is controlled by a control unit 42 which, for this purpose, processes signals in which various operating parameters of the internal combustion engine 10 are represented. In the illustration in FIG. 1A, these are in particular signals mL of the air mass flow rate meter 36, a signal FW of a request of a driver signal transmitter 44, which senses a torque requirement of the driver, and a signal n of a rotational speed signal transmitter 46 which senses a rotational speed n of a crankshaft of the internal combustion engine 10, as well as the geodetic altitude above zero with an ambient pressure sensor.

Of course, modern internal combustion engines 10 are equipped with a plurality of further signal transmitters and/or sensors which are not illustrated here for reasons of clarity. Examples of such sensors are temperature sensors, pressure sensors, exhaust gas sensors, etc. The listing of the signal transmitters 36, 44 and 46 is not intended to be exclusive here. In addition, it is not necessary for there to be a separate sensor for each operating parameter which is processed by the control unit 42 because the control unit 42 can model various operating parameters using computing models based on other measured operating parameters.

On the basis of the received signal transmitter signals, the control unit 42 forms, inter alia, manipulated variables for setting the torque which is to be generated by the internal combustion engine 10. In the embodiment in FIG. 1A, these are, in particular, manipulated variables S_K for actuating an injector 24, S_Z for actuating the sparkplug 26, S_L_DK for actuating the throttle valve actuator 34 and S_L_SRK for actuating the intake manifold valve actuator 40.

Moreover, the control unit 42 is configured, in particular programmed, to implement the method according to the invention or one of its configurations and/or to control the corresponding method sequence.

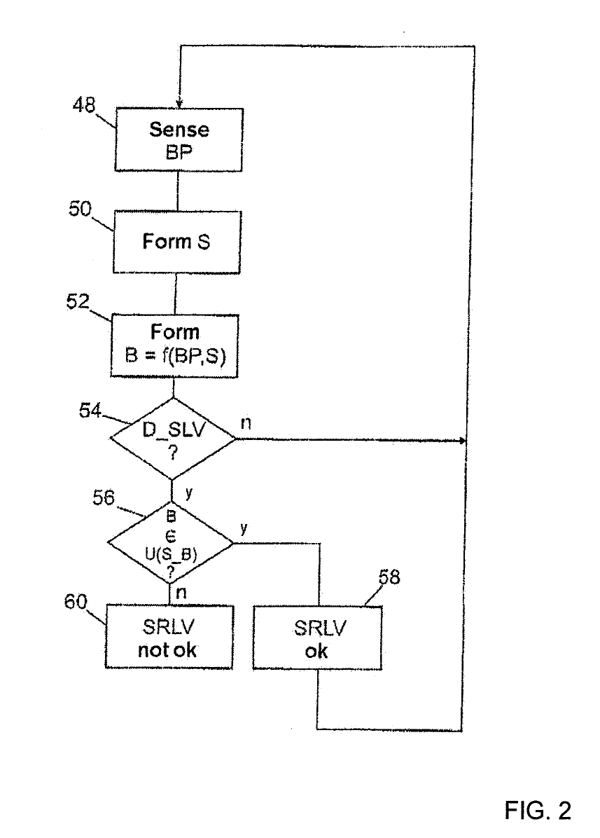

FIG. 2 shows a flowchart as an exemplary embodiment of a method according to the invention as controlled by the control unit 42. For this purpose, in a step 48, operating parameters BP of the internal combustion engine 10 are sensed and processed to form manipulated variables S for controlling the internal combustion engine 10. In particular, the signals mL of the air mass flow rate meter 36, the signal FW of the request of the driver signal transmitter 44 and the rotational speed n, measured by the rotational speed signal transmitter 46, of the internal combustion engine 10 are sensed as operating parameters BP.

The control unit 42 forms, as manipulated variables S, in particular the manipulated variables S_Z, S_K, S_L_DK and S_L_SRK, mentioned in conjunction with FIG. 1A. In this context, when there is a functionally capable adjustment of the length of the intake manifold, the control unit 42 sets a first, comparatively large intake manifold length SRL_L when there is a first, comparatively low rotational speed n1, and sets a second, comparatively small intake manifold length SRL_K when there is a second, comparatively high rotational speed n2. In a step 52, a measure B for an actual value of the power P or of the torque M of the internal combustion engine 10 is formed from operating parameters BP which are sensed for the control of the internal combustion engine 10 during its operation.

A preferred configuration provides for the measure B to be determined as a function of an integral of a quantity of air flowing into the internal combustion engine 10, and thus ultimately on the basis of the signal mL of the air mass flow rate meter 36. When the value of the quantity of air which flows into the internal combustion engine 10 rises and there is a constant efficiency level of other influencing variables such as the ignition and the formation of mixture, which can be influenced by the manipulated variables S_Z and S_K, the torque of the internal combustion engine 10 rises. Due to the integration, rapid fluctuations of the quantity of air which is sensed as an instantaneous value mL are damped. For this reason, the torque values are represented with a degree of accuracy in the value of the integral which permits the torque M to be determined quantitively with a degree of accuracy which is sufficient for the purpose of checking.

An alternative configuration provides for the measure B to be formed as a function of an integral of a modeled torque signal in the control unit 42 of the internal combustion engine 10.

Modern engine controllers coordinate all the torque requests to the internal combustion engine 10 consistently at a torque level, that is to say on the basis of the torque requests and the influences of manipulated variables S_K, S_Z, S_L_DK, S_L_SRK on the actual torque. In this context, inter alia, a theoretically optimum, induced torque of the internal combustion engine 10 is formed from current values of the charge, the excess air factor lambda, the ignition angle and the rotational speed. An actual value of the torque M which is generated by the internal combustion engine 10 is obtained from the efficiency levels of the actuation interventions used for calculating and outputting manipulated variables.

This configuration is utilized for checking by the torque model which is calculated in the control unit 42 in any case, and it is based on the knowledge that the accuracy of the torque calculation which is known per se and is used for control purposes is sufficiently high for the purpose of the checking.

Subsequent to the formation of the measure B, it is checked in step 54 whether the adjustment SRLV of the length of the intake manifold is to be checked D_SRLV. In this context, one preferred configuration provides for the method to be carried out in a full-load operating state of the internal combustion engine 10. In this state, the internal combustion engine 10 operates in an unthrottled fashion at an operating point which can be set reproducibly with a sufficient degree of accuracy, which is important for the reliability of the predefinition of the setpoint values and the calculation of the actual values and thus for the reliability of the setpoint value/actual value comparison.

Correspondingly, in this configuration in step 54 it is checked whether the internal combustion engine 10 is operating under full load. This is the case, for example, when the throttle valve 32 is fully opened. Alternatively or additionally, the full-load operating state can also be detected from other operating parameters BP such as the value of a relative combustion chamber charge, which has been standardized to the maximum possible combustion chamber charge under standardized conditions. Alternatively or additionally, the full-load operating state can also be detected from the fuel measurement signal which corresponds to the relative combustion chamber charge.

A further configuration provides that only measures during whose formation the rotational speed n of the internal combustion engine 10 has passed through a predetermined bandwidth of rotational speed values are utilized. It has become apparent that the limitation on the checking for acceleration processes which is associated with the bandwidth increases the reliability of the results which are obtained. Correspondingly, with this configuration, it is checked in step 54 whether the aforesaid rotational speed bandwidth has been passed through when an acceleration occurs under full load.

If the conditions for checking of the adjustment of the length of the intake manifold are not present, the interrogation in step 54 receives a negative response and the program branches back to step 48 so that the loop composed of steps 48 to 54 is run through repeatedly until in step 54 it is detected that the adjustment of the length of the intake manifold is to be checked.

In this case, it is checked in step 56 whether the measure B, formed in step 52, for an actual value of the power or of the torque of the internal combustion engine 10 is located in an area U surrounding a predetermined setpoint value S_B which represents a functionally capable adjustment of the length of an intake manifold. The surrounding area U can be defined in one embodiment as an interval (S_B−dB; S_B+dB), where dB can have an order of magnitude of three to 5% of S_B.

The interrogation in step 56 thus constitutes a configuration of a setpoint value/actual value comparison. If the interrogation in step 56 receives a positive response, the actual value corresponds, with a sufficient degree of accuracy, to the setpoint value so that the adjustment of the length of the intake manifold in step 58 is assessed as being functionally capable (ok) as a function of the result of the comparison. If, on the other hand, the interrogation in step 56 receives a negative response, the actual value deviates from the setpoint value to such an extent that the adjustment of the length of the intake manifold in step 60 is assessed as being not functionally capable (not ok).

Within the scope of a further configuration, a first measure for an actual value of the power or of the torque of the internal combustion engine is formed when there is a comparatively low rotational speed, and a fault is suspected in the adjustment of the length of the intake manifold if the first measure is lower than a first setpoint value which is predetermined for the comparatively low rotational speed. In this context, a rotational speed always applies as a low rotational speed if it is below a switch-over rotational speed at which a functionally capable adjustment of the length of the intake manifold switches over the intake manifold 30 between the small intake manifold length SRL_K and the large intake manifold length SRL_L. A typical value for rotational speeds for a spark ignition engine is between 2000 and 4000 rpm.

In this configuration, the method is carried out according to FIG. 2 when there are correspondingly low rotational speeds. If, in this context, the step 60 is reached, a suspicion of a fault is set in the control unit 42 and stored, and the suspicion can be confirmed or cancelled by further measures.

This configuration takes into account the fact that the reliability of the detection of a fault in the adjustment of the length of the intake manifold is lower at low rotational speeds than at relatively high rotational speeds. This is due to the fact that the values of the quantity of air and of the torque are smaller at low rotational speeds than at relatively high rotational speeds.

As a result of the formation of a suspicion, deviations of an actual value from a setpoint value are registered, but they constitute unambiguous information only if the suspicion is either cancelled or confirmed by further measures. It is also advantageous that this configuration can be carried out comparatively frequently in the normal traveling mode since acceleration processes which start from low rotational speeds occur frequently.

If, when a suspicion has been set, acceleration occurs later in the traveling mode under full load when there is a comparatively high rotational speed, the method is repeated according to FIG. 2 in a modified form. The modification consists in the fact that when the rotational speed is comparatively high, it is attempted to set a long intake manifold length. In other words, the control unit outputs a manipulated variable S_L_SRK to the intake manifold valve actuator 40, with which manipulated variable S_L_SRK the latter sets a large intake manifold length SRL_L when the adjustment of the length of the intake manifold is functionally capable.

In addition, the control unit 42 forms a second setpoint value or anticipated value of the power P or of the torque M of the internal combustion engine 10 for the long intake manifold length SRL_L and the high rotational speed. Since short intake manifolds give rise to larger charges than long intake manifolds at the high rotational speed, the anticipated value which is formed for long intake manifolds will be smaller than a setpoint value which is valid for short intake manifolds. The control unit 42 then determines a second measure for an actual value of the power P or of the torque M at the comparatively high rotational speed. If the actual value which is formed in this way exceeds the anticipated value which is formed for long intake manifolds, this confirms the suspicion that the large intake manifold length SRL_L cannot be set. A corresponding fault message is then stored in the control unit 42. In one preferred configuration, the fault is stored in such a way that it can be read out at the next visit to a repair shop, but is not displayed in the normal traveling mode.

At high rotational speeds, the control system would set a short intake manifold length SRL_K in the normal traveling mode. Therefore the possible fault of an intake manifold valve 38 which sticks in the state with a short intake manifold length SRL_K is not perceptible in the traveling mode at high rotational speeds. As a result of the attempt at an active adjustment of the intake manifold length to a relatively long value SRL_L, it becomes possible, however, to detect the aforesaid fault at high rotational speeds and thus high values of the quantity of air and of the torque.

If the setting of a long length SRL_L of the intake manifold functions, a loss of torque and of power occurs at high rotational speeds. This is in principle undesired since such losses briefly restrict the acceleration capability of the vehicle and can thus annoy the driver. In order to avoid this annoyance, this configuration is carried out only if a suspicion of a fault has previously been set in advance at a relatively low rotational speed. The implementation of the configuration at the high rotational speed then has the advantage that the set suspicion of a fault is either cancelled or confirmed.

A further advantage is that confirmation of the suspicion of a fault results in that the long intake manifold length cannot be set. The abovementioned annoying reaction by the vehicle does not occur either. Since the configuration is carried out only when a suspicion of a fault has been set, there is a high level of probability that it is carried out only when a fault is actually present. Reactions by the vehicle which annoy the driver, and which could result from active actuation of the adjustment of the intake manifold length at high rotational speeds, are very largely avoided in this way.

A further configuration provides that, when there is a comparatively high rotational speed, a third setpoint value of the power or of the torque of the internal combustion engine is formed for a short intake manifold length, a third measure for an actual value of the power or of the torque of the internal combustion engine is formed when there is a comparatively high rotational speed and is compared with the third setpoint value, and a fault message is generated if the third measure is lower than the third setpoint value. This configuration has the advantage that it permits detection of the fault which occurs when the short intake manifold length cannot be set.

With regard to FIG. 1, the invention is described with respect to an internal combustion engine 10 which operates with internal mixture formation through injection directly into a combustion chamber 12, and with spark ignition. However, it is to be noted that the invention is not restricted to such internal combustion engines 10 but can also be used in conjunction with internal combustion engines which operate with external mixture formation (for example intake manifold injection) or auto-ignition. In addition, it is conceivable to use the invention both in supercharged and in non-supercharged internal combustion engines. In addition, the invention is explained with regard to an adjustment of the length of an intake manifold which operates with an intake manifold valve. However, the invention can also of course be used for adjustments of the length of intake manifolds which operate with different mechanisms, for example with intake manifolds which can be extended and pushed in in the manner of a telescope.

1. A method for checking an adjustment of a length or volume of an intake manifold in an internal combustion engine, and when there is a functionally capable adjustment of the length of the intake manifold the internal combustion engine is operated with a first, comparatively large intake manifold length during a first, comparatively low rotational speed, and the internal combustion engine is operated with a second, comparatively small intake manifold length during a second, comparatively high rotational speed being high relative to the first, comparatively low rotational speed, the first, comparatively large intake manifold length being larger than the second, comparatively small intake manifold length, the method comprises the steps of:
forming a measure for an actual value of one of power and torque of the internal combustion engine from operating parameters sensed for controlling the internal combustion engine during operation;
comparing the measure with a predetermined setpoint value; and
determining a completion of a successful adjustment of one of the length and the volume of the intake manifold in dependence on a result of a comparison.

2. The method according to claim 1, which further comprises determining the measure in dependence on an integral of a quantity of air flowing into the internal combustion engine.

3. The method according to claim 1, which further comprises forming the measure in dependence on an integral of a torque signal formed in a control unit of the internal combustion engine.

4. The method according to claim 1, which further comprises performing the method during a full-load operating state of the internal combustion engine.

5. The method according to claim 4, which further comprises using only measures formed during rotational speeds of the internal combustion engine that passed through a predetermined bandwidth of rotational speed values.

6. The method according to claim 1, which further comprises:
forming a first measure for the actual value of one of the power and the torque of the internal combustion engine when there is the first, comparatively low rotational speed; and
suspecting a fault in the adjustment of the length of the intake manifold if the first measure is lower than a first setpoint value predetermined for the comparatively low rotational speed.

7. The method according to claim 6, which further comprises performing the following steps when there is the second, comparatively high rotational speed;
signaling the intake manifold to form the first, comparatively large intake manifold length;
forming a second setpoint value of one of the power and the torque of the internal combustion engine for the first, comparatively large intake manifold length;
forming a second measure for the actual value of one of the power and the torque when there is the second, comparatively high rotational speed; and
confirming a suspicion of the fault if the second measure is higher than the second setpoint value.

8. The method according to claim 1, which further comprises performing the following steps when there is the second, comparatively high rotational speed:
forming a further setpoint value of one of the power and the torque of the internal combustion engine for the second, comparatively small intake manifold length;
forming a further measure for the actual value of one of the power and the torque of the internal combustion engine when there is the second, comparatively high rotational speed;
comparing the further measure with the further setpoint value; and
generating a fault message if the further measure is lower than the further setpoint value.

9. A control unit configured to check an adjustment of a length of an intake manifold in an internal combustion engine, and when there is a functionally capable adjustment of the length of the intake manifold, the internal is operated with a first, comparatively large intake manifold length when there is a first, comparatively low rotational speed, and is operated with a second, comparatively small intake manifold length when there is a second, comparatively high rotational speed, the control unit comprising:
a controller programmed to:
form a measure for an actual value of one of power and torque of the internal combustion engine from operating parameters sensed for controlling the internal combustion engine during operation;
compare the measure with a predetermined setpoint value; and
determining a completion of a successful adjustment of the length of the intake manifold in dependence on a result of a comparison.

10. The control unit according to claim 9, wherein said controller is further programmed to determine the measure in dependence on an integral of a quantity of air flowing into the internal combustion engine.

11. The control unit according to claim 9, wherein said controller is further programmed to form the measure in dependence on an integral of a torque signal formed in a control unit of the internal combustion engine.

12. The control unit according to claim 9, wherein said controller is further programmed to perform the method during a full-load operating state of the internal combustion engine.

13. The control unit according to claim 12, wherein said controller is further programmed to use only measures formed during rotational speeds of the internal combustion engine that passed through a predetermined bandwidth of rotational speed values.

14. The control unit according to claim 9, wherein said controller is further programmed to:
form a first measure for the actual value of one of the power and the torque of the internal combustion engine when there is the first, comparatively low rotational speed; and
suspect a fault in the adjustment of the length of the intake manifold if the first measure is lower than a first setpoint value predetermined for the first, comparatively low rotational speed.

15. The control unit according to claim 14, wherein said controller is further programmed to perform the following steps when there is the second, comparatively high rotational speed:
signal the intake manifold to form the first, comparatively large intake manifold length;
form a second setpoint value of one of the power and the torque of the internal combustion engine for the first, comparatively large intake manifold length;
form a second measure for an actual value of one of the power and the torque when there is the second, comparatively high rotational speed; and
confirm a suspicion of the fault if the second measure is higher than the second setpoint value.

16. The control unit according to claim 9, wherein said controller is further programmed to perform the following steps when there is the second, comparatively high rotational speed:
form a further setpoint value of one of the power and the torque of the internal combustion engine for the second, comparatively small intake manifold length;
form a further measure for an actual value of one of the power and the torque of the internal combustion engine when there is the second, comparatively high rotational speed;
compare the further measure with the further setpoint value; and
generate a fault message if the third measure is lower than the third setpoint value.
